(19) United States
(12) Patent Application Publication
(10) Pub. No.: US 2018/0072088 A1
(43) Pub. Date: Mar. 15, 2018

(54) SECURITY ELEMENT

(71) Applicant: GIESECKE+DEVRIENT CURRENCY TECHNOLOGY GMBH, München (DE)

(72) Inventor: Gianluca MESSA, Tegernsee (DE)

(21) Appl. No.: 15/559,922

(22) PCT Filed: Mar. 14, 2016
(86) PCT No.: PCT/EP2016/000459

§ 371 Date: Sep. 20, 2017

(30) Foreign Application Priority Data
Mar. 20, 2015 (DE) 10 2015 003 665.3

(51) Int. Cl. B42D 25/378; B42D 25/45; B42D 25/23; B42D 25/29

(52) U.S. Cl. CPC B42D 25/378; B42D 25/29; B42D 25/23; B42D 25/45

(57) ABSTRACT

A security element comprises a carrier material having a first and a second principal face which oppose each other; an absorber layer, a dielectric layer and a partially reflecting layer which are arranged on the first principal face. The dielectric layer is arranged between the absorber layer and the partially reflecting layer and the absorber layer is arranged between the dielectric layer and the carrier material; and a contrast layer which lies nearest the absorber layer starting out from the partially reflecting layer, the dielectric layer and the absorber layer. A method for manufacturing is provided for making the security element, and a value document has the security element.

This invention relates to a security element, a method for manufacturing a security element and a value document having a security element.

Value documents as intended by the invention are, inter alia, bank notes, shares, bonds, deeds, vouchers, checks, air tickets, high-value admission tickets, labels for product authentication, credit cards or cash cards, but also other documents at risk of forgery, such as passports, identification cards or other identity documents.

Value documents, in particular bank notes, are usually produced from paper substrates, polymer substrates or combinations of paper and polymer which have particular security features, such as a security thread at least partly incorporated into the paper or a watermark. As further security features, so-called window foils, security threads, security bands can be bonded/laminated to the value document or incorporated therein. Security elements usually comprise a polymer or polymer compositions as a carrier material or base material. Typically, security elements have optically variable security features such as holograms or certain color-shift effects to thereby guarantee better anti-forgery security. The particular advantage of optically variable security elements is that the security features on said security elements cannot be imitated by mere copying using a copying machine, since effects of an optically variable security feature are lost or even only appear black through copying.

In existing value documents with optically variable security elements having color-shift effects, however, it is disadvantageous that the manufacture of the required thin-film elements is very time-consuming and cost-intensive. For a definition and functionality of thin-film elements, reference is made by way of example to the prints WO 2009/149831A2 and WO2011/032665A1.

Further, the incorporation of additional security features such as so-called negative patterns or negative text in the region of the color-shift effects/thin-film elements is elaborate and can frequently not be done with satisfactory quality. For example, incorporating negative patterns into a region with a color-shift effect requires that the layers of the thin-film element that lead to the color-shift effect must be removed at least partly at the places where the negative patterns are to be incorporated.

It is hence an object of the present invention to provide a method that enables security elements having optically variable effects to be manufactured in a less time-consuming and cost-intensive manner.

It is likewise an object of the present invention to provide a method that enables security elements having optically variable effects and additional negative patterns to be manufactured in high quality.

These objects are achieved by the subject matter of the independent claims. Preferred embodiments are defined in the dependent claims.

A first aspect of the invention relates to a security element comprising: a carrier material which has a first and a second principal face which oppose each other; an absorber layer, a dielectric layer and a partially reflecting layer which are arranged on the first principal face, wherein the dielectric layer is arranged between the absorber layer and the partially reflecting layer, and the absorber layer is arranged between the dielectric layer and the carrier material; and a contrast layer which lies nearest the absorber layer starting out from the partially reflecting layer, the dielectric layer and the absorber layer.

The carrier material can have one or several regions to be coated in which the absorber layer, the dielectric layer and the partially reflecting layer are arranged. The carrier material is preferably a foil-like material. The at least one region to be coated is preferably arranged at a principal face of the carrier material. If the carrier material has a several regions to be coated, they can be arranged only at one of the two principal faces or at both principal faces of the carrier material. In particular, a region to be coated can be a thin-film-element region or a color-shift region.

The carrier material's region to be coated can have different areal forms. For example, the region to be coated can be configured as a rectangular, oval, star-shaped or wiggly configuration. The shape and size of the region to be coated is preferably defined or determined in one method step. The carrier material's region to be coated can have a surface structure and/or surface condition that differs from other regions of the carrier material. The carrier material has, in other words, an area which is defined as a region to be coated. Preferably, the absorber layer, the dielectric layer, and the partially reflecting layer are arranged or applied all over in the region to be coated. The absorber layer, the dielectric layer and the partially reflecting layer can, for example, be applied or vapor-deposited by means of physical vapor deposition. In particular, the security element can have a relief structure. Preferably, this relief structure can be provided at/on the first principal face of the carrier medium. For example, the relief structure can be provided by means of an embossed emboss-lacquer layer which is arranged on the first principal face of the carrier medium. Further, the relief structure can be provided in the dielectric layer so that the dielectric layer has no constant layer thickness.

The security element can be configured as a so-called T-Patch or T-LEAD, wherein the carrier medium is removed before the applying to a value-document substrate. Alternatively, the security element can also be configured as a so-called L-Patch or L-LEAD, wherein the carrier medium is connected to the value-document substrate. I.e. the carrier medium is not removed from the security element.

In particular, the layer sequence of partially reflecting layer, dielectric layer and absorber layer, wherein the dielectric layer is arranged between partially reflecting layer and absorber layer, forms a thin-film composition with a color-shift effect or a thin-film element with a color-shift effect. In dependence on the layer thicknesses of the partially reflecting layer, the structured spacer layer and the absorber layer, transmission-view color effects can also be present instead of color-shift effects.

Advantageously, the security element has a protective layer which is arranged in the (entire) region to be coated. Preferably, the protective layer is arranged on/at the partially reflecting layer.

Preferably, the protective layer comprises a protective lacquer. Alternatively or additionally, the protective layer comprises a heat-seal lacquer and/or a primer.

Preferably, the carrier material comprises a carrier foil. Particularly preferably, the carrier material contains polyethylene terephthalate (PET) and/or polypropylene (PP), the carrier material being particularly preferably made of PET or PP.

A security element according to this invention can contain in particular a foil or a multilayer substrate, wherein the multilayer substrate can also have a combination of fabric substrates and foils. For example, the security element can comprise a window region which serves to fill, or bridge, a hole in a value document or in the paper substrate of the value document. In other words, with the security element, a security window can be incorporated/applied in a value document. Preferably, the region to be coated is arranged in the window region of the security element. Alternatively, the security element can be applied to a value document, for example laminated or bonded thereto. The security element can be a security thread or security band, windowed thread, patch or the like.

Advantageously, by means of employing a partially reflecting layer in combination with a contrast layer, it can be achieved that the thin-film element, i.e. the partially reflecting layer, the dielectric layer and the absorber layer, are opaque in transmission view in the regions with contrast layer, while the thin-film element is semi-transparent in the regions without contrast layer. Consequently, additional information items can be provided very simply and quickly in the security element by structuring the contrast layer.

Preferably, the contrast layer is a structured layer, i.e. structured contrast layer.

In particular, a structured contrast layer is to be understood to mean that the contrast layer forms a pattern or motif which is visible for a viewer upon viewing the security element.

A structured contrast layer is to be understood in particular to mean that the contrast layer is not arranged uniformly or all over at/over the absorber layer or the carrier medium. Rather, due to the structured contrast layer, there are places/subregions in the region to be coated where the contrast layer is left out.

After arranging the structured contrast layer, there are two different regions or portions in the region to be coated, namely
first regions/portions which comprise the carrier material, the partially reflecting layer, the dielectric layer, the absorber layer and the (structured) contrast layer and
second regions/portions which comprise the carrier material and the partially reflecting layer, the dielectric layer and the absorber layer but no (structured) contrast layer. In other words, in this case the absorber layer is covered by the structured contrast layer only regionally or are arranged one over the other only in some subregions of the region to be coated.

Preferably, the structured contrast layer forms a predetermined motif or pattern such as a character, a character string and/or an image. This motif or pattern determines the structure of the structured contrast layer. The motif can for example be visible or recognizable to a viewer when the viewer looks at the security element in transmission view, namely in the direction of the principal face normal or perpendicular to the carrier material's principal face which has the region to be coated.

Preferably, the contrast layer is a layer of dark printing ink. Alternatively the contrast layer is a layer of a dark resist lacquer.

Preferably, the structured contrast layer is arranged/applied in the form of a motif by printing technology.

Preferably, the structured contrast layer is arranged by means of one or several rollers and/or cylinders. In particular, the number of rollers can vary. The rollers/cylinders can transport lacquer and/or ink depending on the mutual speed. The arrangement of the motif, or the motif printing, is preferably effected by a letterpress form.

Preferably, the structured contrast layer is applied by means of Flexo printing process. Alternatively or additionally, the structured contrast layer is applied by means of gravure printing process. Alternatively or additionally, the structured contrast layer is applied by means of ink jet printing process. Alternatively or additionally, the structured contrast layer is applied by means of offset printing process. Alternatively or additionally, the structured contrast layer is applied by means of screen printing process.

Further preferably, the contrast layer has a layer thickness of 1 μm to 15 μm, preferably 2 μm to 4 μm. Preferably, the layer thickness of the contrast layer is a constant layer thickness.

Preferably, the security element comprises an additional layer which is arranged between the absorber layer and the contrast layer.

Further preferably, the additional layer is a structured layer, i.e. an additional, structured layer, for example in the form of a pattern or motif. Further preferably the additional layer has a constant layer thickness. Preferably, the layer thickness of the additional layer lies in the region of 1 μm to 15 μm, preferably in the region from 1 μm to 5 μm and/or 5 μm to 10 μm and/or 10 μm to 15 μm.

Further preferably, the additional layer comprises a magnetic printing ink, a fluorescent imprint or a machine-readable imprint. Further preferably, the additional layer comprises infrared-visible and/or thermochromic printing inks.

Preferably, the partially reflecting layer has a layer thickness of 50 Å (5 nm) to 500 Å (50 nm) (Angstrom), preferably 100 Å (10 nm) to 300 Å (30 nm). Further preferably, the layer thickness of the partially reflecting layer is constant. Preferably, the partially reflecting layer is a metallic layer, preferably of aluminum or an aluminum alloy.

Preferably, the absorber layer has a layer thickness of 30 Å (0.3 nm) to 200 Å (20 nm), preferably 50 Å (5 nm) to 100 Å (10 nm). Further preferably, the layer thickness of the absorber layer is constant. Preferably, the absorber layer is a metallic layer, preferably of chromium.

Preferably, the dielectric layer has an optical thickness of two quarter wavelengths (λ/2) in relation to a wavelength of 400 nm (2 Quarter Wave Optical Thickness, 2 QWOT) to nine quarter wavelengths (9λ/4) (9 Quarter Wave Optical Thickness; 9 QWOT) in relation to a wavelength of 700 nm, preferably the layer thickness has a layer thickness between 2 QWOT (2λ/4) to 8 QWOT (8λ/4) in relation to a wavelength between 400 nm and 700 nm. Preferably, the dielectric layer in the visible region is transparent or translucent.

Preferably, the layer thickness of the dielectric layer is a constant layer thickness.

Preferably the security element has a reflective layer which is arranged at the side of the contrast layer facing away from the absorber layer.

Preferably, the reflective layer is a structured reflective layer. Further preferably, the reflective layer and the contrast layer are identical or structured substantially equal. In other words, the reflective layer and the contrast layer have congruent regions which are free of the reflective layer and the contrast layer.

Preferably, the contrast layer is arranged between the absorber layer and the carrier material.

Preferably, the contrast layer is arranged on the second principal face of the carrier material.

A further aspect relates to a method for manufacturing a security element comprising the steps of:
supplying a carrier material having a first and a second principal face which oppose each other
arranging of an absorber layer, a dielectric layer and a partially reflecting layer on the first principal face; wherein the dielectric layer is arranged between the absorber layer and the partially reflecting layer, and the absorber layer is arranged between the dielectric layer and the carrier material;
arranging of a contrast layer which lies nearest the absorber layer starting out from the partially reflecting layer, the dielectric layer and the absorber layer.

The method comprises in particular suitable method steps to manufacture a security element with one or several of the previously described aspects or properties.

Preferably, the contrast layer is a structured layer.

Preferably, the contrast layer comprises a layer of dark printing ink. Alternatively or additionally, the contrast layer comprises a layer of a dark resist lacquer.

A further aspect relates to a value document, in particular a bank note, having a value-document substrate and at least one security element which comprises one or several of the previously described aspects.

A security element is preferably applied to/incorporated into a value-document substrate. A value-document substrate can have paper, polymer or a paper-polymer combination. In the case of a bank note made of polymer or a paper-polymer combination as a value-document substrate, the carrier material of the security element can be a partial region of the value-document substrate. For example, the value-document substrate can be a polymer foil and the carrier material of the security element is a partial region of said polymer foil.

When the security element has been embedded into a value document, the upper side and the underside of the security element preferably extend (substantially) parallel to the upper side and underside of the value-document substrate. The upper side and underside of the value document as well as those of the security element can also be designated principal faces. Said principal faces render relevant information to a viewer. Consequently, the principal faces are visible to a viewer viewing a value document having a security element. For example, a principal face of a bank note can render the value of the bank note as well as its serial number. Accordingly, an upper side and underside of a security element, like those of a value document, can also be regarded as first and second principal faces.

The invention will be explained hereinafter on the basis of preferred embodiments in connection with the attached figures, whose representation does without a true-to-proportion and true-to-scale rendition in order to increase the illustrative value.

There are shown:

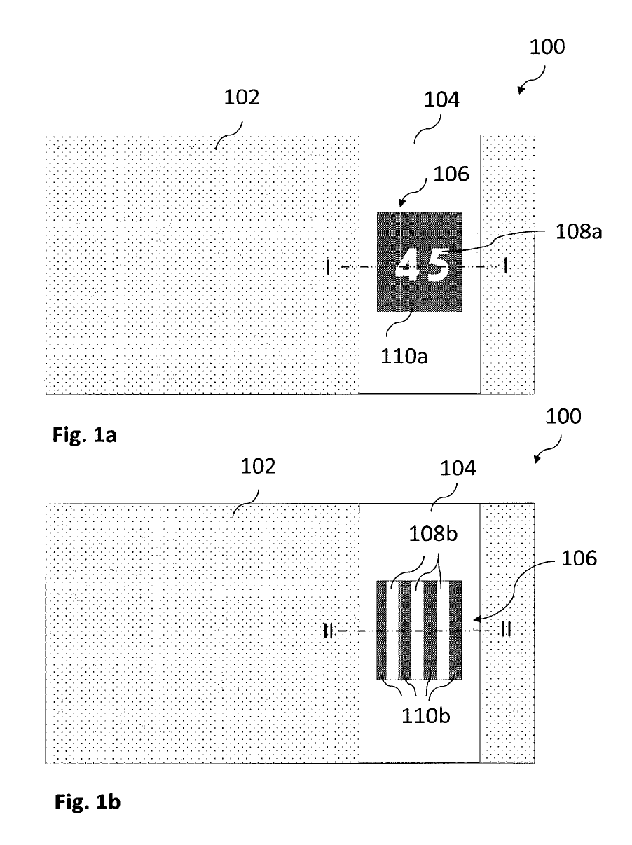

FIG. 1a, 1b a schematic representation of a value document having a security element;

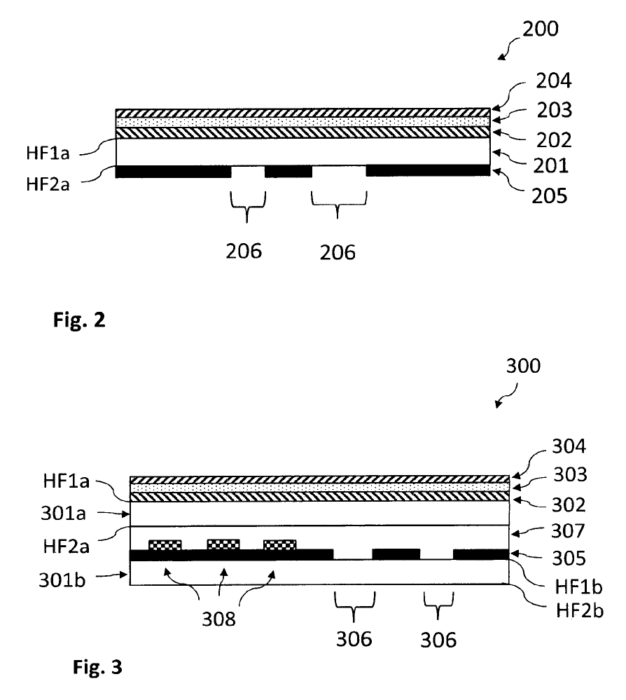

FIG. 2 a schematic sectional representation of a security element according to a variant;

FIG. 3 a schematic sectional representation of a security element according to a further variant;

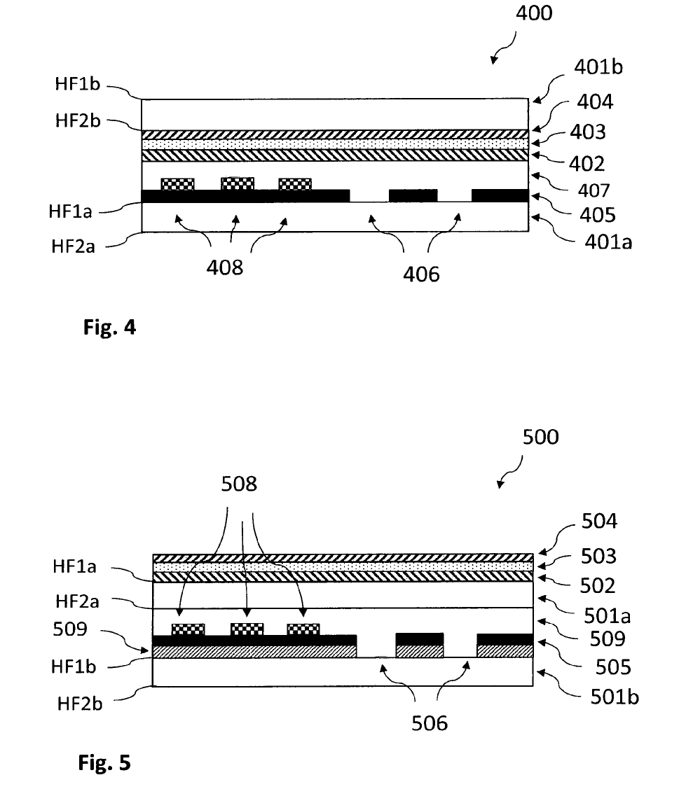

FIG. 4 a schematic sectional representation of a security element according to a further variant;

FIG. 5 a schematic sectional representation of a security element according to a further variant;

FIGS. 1a and 1b respectively show a schematic plan view of a principal face of a value document 100 having a value-document substrate 102 and a security element 104, wherein the security element 104 is firmly connected to the value-document substrate 102, e.g. embedded into the value-document substrate 102 or applied to the value-document substrate. The security element 104 can also be a partial region of the value-document substrate 102. The security element 104 has an area defined as a region to be coated 106. The region to be coated 106 is preferably a color-shift or thin-film-element region which has a partially reflecting layer, an absorber layer and a dielectric layer. The region to be coated 106 has a contrast layer-free region 108 as well as a contrast layer region 110.

FIG. 1a shows the number 45 as a contrast layer-free region 108a. FIG. 1b shows three stripes as a contrast layer-free region 108b. A contrast layer-free region can further have any form or configuration. For example, a contrast layer-free region might have the form of a church or an animal. Preferably, a contrast layer-free region enables a viewer to recognize the contrast layer-free region in plan view and/or in transmission view. Preferably, the security element is more transparent, or at least semi-transparent, in the contrast layer-free region than in the contrast layer region so that at least a part of the light impinging on the security element is transmitted in the contrast layer-free region. The security element 104 contains a carrier material which preferably consists of polyethylene terephthalate (PET), and has a region 106 to be coated. The contrast layer region 110, which is a subregion or partial region of the region to be coated 106, comprises at least one partially reflecting layer, a dielectric layer and at least one absorber layer. In comparison to the contrast layer region 110, the contrast layer-free region 108 has at least no contrast layer. Accordingly, it is clearly evident that the contrast layer is not present all over or uniformly in the region to be coated 106, but only/exclusively in the contrast layer region 110. In other words the contrast layer is present as a structured contrast layer.

The composition of a region to be coated 108 having contrast layer region 110 and contrast layer-free region 108 will be explained more closely hereinafter with the aid of FIGS. 2 to 5.

FIG. 2 shows the sectional view of a security element 200 with a carrier material 201. The carrier material 201 has a first principal face HF1a and a second principal face HF2a. An absorber layer 202 is arranged at the principal face HF1a of the carrier material. A dielectric layer 203 is arranged at the absorber layer 202. A partially reflecting layer 204 is arranged at the dielectric layer 203. A structured contrast layer 205 is arranged at the second principal face HF2a of the carrier material 201. Contrast layer-free regions 206 are formed by the structuring of the contrast layer 205. In particular, the sectional representation shown in FIG. 2 can correspond to a section through the “4” along the line I-I according to FIG. 1a or a part along the line II-II according to FIG. 1b.

FIG. 3 shows a security element 300 which has a (first) carrier material 301a having a first principal face HF1a and a second principal face HF2a. This sectional view can correspond for example to a part of a sectional view along the line I-I as shown in FIG. 1a, or along the sectional line II-II according to FIG. 1b. FIG. 3 shows a partially reflecting layer 304, a dielectric layer 303 and an absorber layer 302. These three layers 304, 303 and 302 are arranged at the first principal face HF1a of the (first) carrier material 301a. The security element 300 additionally has the second carrier material 301b which has a first principal face HF1b. A structured contrast layer 305 is arranged at the first principal face HF1b so that contrast layer-free regions 306 result. Further, the security element 300 has an additional structured layer 308. The additional structured layer 308 can for example be a layer of magnetic printing ink. The security element 300 results by joining together the (first) carrier material 301a and the (second) carrier material 301b. Preferably, the (first) carrier material 301a and the (second) carrier material 301b are joined together after arranging the layers 308 and 305. For example, the carrier materials 301a and 301b can be interconnected by an adhesive layer 307. Therefore there results a composition, wherein the additional structured layer 308 and the structured contrast layer 305 are arranged on/at the second principal face HF2a of the (first) carrier material 301a.

FIG. 4 shows the sectional view of a security element 400 with a carrier material 401a. The (first) carrier material 401a has a first principal face HF1a and a second principal face HF2a. A contrast layer 405, which can be a structured contrast layer with contrast layer-free regions 406, is arranged at or on the first principal face HF1a. An additional structured layer 408 is arranged at/on the contrast layer 405. An absorber layer 402, a dielectric layer 403 and a partially reflecting layer 404 are arranged over or at the additional structured layer 408. A (second) carrier material 401b is arranged at or over the partially reflecting layer 404. When manufacturing the security element 400, for example the first principal face HF1a of the (first) carrier material 401a can be coated with the contrast layer 405 and the additional layer 408. In a further step, the second principal face HF2b of the (second) carrier material 401b can be coated with the layers 404, 403 and 402. In a further step, the second principal face HF2b of the (second) carrier material 401b and the first principal face HF1a of the (first) carrier material 401a can then be interconnected. For example, an adhesive layer 407 can be employed for this purpose.

FIG. 5 shows the schematic sectional view of a security element 500 with a carrier material 501a. The (first) carrier material 501a has a first principal face HF1a and a second principal face HF2a. An absorber layer 502, a dielectric layer 503 and a partially reflecting layer 504 are arranged at or on the first principal face HF1a. An additional layer 508 and a contrast layer 505 are arranged at the second principal face HF2b of the (first) carrier material 501a. Further, a reflective layer 507 is arranged at the contrast layer 505. This reflective layer 507 can be generated by printing technology or by vapor deposition. The (second) carrier material 501b is arranged at the reflective layer 507. The reflective layer 507 and the contrast layer 505 preferably have the identical structuring. Therefore, contrast layer-free regions 506 are at the same time reflective layer-free regions as well. When manufacturing the security element 500, for example the first principal face HF1a of the (first) carrier material 501a can be coated with the layers 502, 503 and 504. In a further step, the first principal face HF2a of the (second) carrier material 501b can be coated with the additional layer 508, the contrast layer 505 and the reflective layer 507. In a further step, the first principal face HF1b of the (second) carrier material 501b and the second principal face HF2a of the (first) carrier material 501a can then be interconnected. For example, an adhesive layer 509 can be employed for this purpose.

Advantageously, a viewer of the security elements 200, 300, 400 and 500 upon viewing in incident light can perceive a homogeneous color-shift effect in the region to be coated 106, whereas the viewer upon viewing in transmitted light can advantageously perceive the contrast layer-free regions 206, 306, 406 or 506 in the form of patterns, signs or motifs.

### LIST OF REFERENCE SIGNS

100 Value document
102 Value document substrate
104 Security element
106 Region to be coated
108 Contrast layer-free region
110 Contrast layer region
200, 300, 400, 500 Security element
201, 301a, 401a, 501a(first) carrier material
301b, 401b, 501b (second) carrier material
202, 302, 402, 502 Absorber layer
203, 303, 403, 503 Dielectric layer
204, 304, 404, 504 Partially reflecting layer
205, 305, 405, 505 Contrast layer
206, 306, 406, 506 Contrast layer-free region
308, 408, 508 Additional layer
HF1a, HF1b 1st principal face of the (first or second) carrier materials
HF2a, HF2b 2nd principal face of the (first or second) carrier materials

1.-11. (canceled)

12. A security element comprising:
a carrier material which has a first and a second principal face which oppose each other;
an absorber layer, a dielectric layer and a partially reflecting layer which are arranged on the first principal face,
wherein the dielectric layer is arranged between the absorber layer and the partially reflecting layer, and the absorber layer is arranged between the dielectric layer and the carrier material; and
a contrast layer which lies nearest the absorber layer starting out from the partially reflecting layer, the dielectric layer and the absorber layer.

13. The security element according to claim 12, wherein the contrast layer is a structured layer;
and/or the contrast layer comprises a layer of dark printing ink or of a dark resist lacquer;
and/or the contrast layer has a layer thickness of 1 μm to 15 μm.

14. The security element according to claim 12, wherein an additional layer is arranged between the absorber layer and the contrast layer, wherein the additional layer is a structured layer and has a (constant) layer thickness of 1 μm to 15 μm.

15. The security element according to claim 12, wherein the partially reflecting layer has a layer thickness of 5 nm to 50 nm, and is a metallic layer.

16. The security element according to claim 12, wherein the absorber layer has a layer thickness of 0.3 nm to 20 nm.

17. The security element according to claim 12, wherein the dielectric layer has an optical thickness of two quarter wavelengths in relation to a wavelength of 400 nm to nine quarter wavelengths in relation to a wavelength of 700 nm, including between two to eight quarter wavelengths in relation to a wavelength between 400 nm and 700 nm, and is a transparent or translucent layer in the visible region.

18. The security element according to claim 12, wherein a reflective layer is arranged at the side of the contrast layer facing away from the absorber layer.

19. The security element according to claim 12, wherein the contrast layer is arranged between the absorber layer and the carrier material;
and/or the contrast layer is arranged on the second principal face of the carrier material.

20. A method for manufacturing a security element comprising the steps of:
supplying a carrier material having a first and a second principal face which oppose each other,
arranging of an absorber layer, a dielectric layer and a partially reflecting layer on the first principal face, wherein the dielectric layer is arranged between the absorber layer and the partially reflecting layer, and the absorber layer is arranged between the dielectric layer and the carrier material;
arranging a contrast layer which lies nearest the absorber layer from the partially reflecting layer, the dielectric layer and the absorber layer.

21. The method according to claim 20, wherein the contrast layer is a structured layer; and/or the contrast layer comprises a layer of dark printing ink or of a dark resist lacquer.

22. A value document, in particular bank note, having a value-document substrate and at least one security element according to claim 12.
